(19) United States
(12) Patent Application Publication
(10) Pub. No.: US 2018/0141778 A1
(43) Pub. Date: May 24, 2018

(54) Device for Servicing an Aircraft on the Ground

(71) Applicant: IPALCO BV, Woerden (NL)

(72) Inventor: Thomas Dreyer, Dietzenbach (DE)

(21) Appl. No.: 15/575,119

(22) PCT Filed: Jun. 6, 2016
(86) PCT No.: PCT/EP2016/062780

§ 371 Date: Nov. 17, 2017

(30) Foreign Application Priority Data
Jun. 4, 2015 (LU) 92730

(51) Int. Cl. B65H 75/40; B64F 1/36; B65H 75/44; H02G 11/02; B64F 1/28

(52) U.S. Cl. CPC B65H 75/403; B64F 1/36; B64F 1/28; H02G 11/02; B65H 75/4484

(57) ABSTRACT

A device for servicing an aircraft on the ground includes: a steerable carriage; a first reel mounted along a first lateral side of the steerable carriage for unwinding a first hose or a cable onto a ground surface, wherein the first hose or a cable has a drop off point near this first lateral side; and a second reel mounted along a second lateral side of the steerable carriage for unwinding a second hose or a cable onto the ground surface, wherein the second hose or a cable has a drop off point near this second lateral side. A control system controls the unwinding speed of the cable or hose from of each of the reels in such a way that in a curve, the control system makes the outer reel unwind faster than the inner reel.

### TECHNICAL FIELD

The present invention generally relates to a device for servicing an aircraft on the ground. It relates more particularly to such a device comprising at least two reels mounted on a steerable carriage for unwinding in parallel at least two hoses or at least two cables or at least one hose and at least one cable onto the ground surface. It further relates to such a device that is also capable of recuperation of the cable(s) or the hose(s) previously laid onto a ground surface.

### BACKGROUND ART

Such a device is for example disclosed in EP 1 404 575 B1.

It is an object of the present invention to modify the prior art device so as to allow for simultaneous laying of at least two cables or of at least two hoses or of at least one hose and at least one cable in a more organized way along a curved path onto a ground surface.

It is also an object of the present invention to modify the prior art device so as to allow for simple and safe recuperation of the cable(s) and/or the hose(s) previously laid onto a ground surface in a curved path, in particular in presence of obstacles or of persons or of reserved traffic areas that cannot be crossed by the cable(s) and/or the hose(s).

It is an additional object of the present invention to make a device for servicing an aircraft on the ground more user-friendly.

### SUMMARY OF INVENTION

According to a first aspect, a steerable carriage has a first lateral side and an opposite second lateral side. A first reel is mounted along the first lateral side of the steerable carriage for unwinding a first hose or a cable onto a ground surface, wherein the first hose or a cable has a drop off point near the first lateral side of the steerable carriage. A second reel is mounted along the second lateral side of the steerable carriage for unwinding a second hose or a cable onto the ground, wherein the second hose or a cable has a drop off point near the second lateral side of the steerable carriage. (The drop-off point is hereby defined as a point in a reference system attached to the carriage and located vertically above the point where the dropped cable/hose touches the ground surface.) In accordance with a first aspect of the invention, a control system controls the unwinding speed of the cable or hose from of each of the reels in such a way that in a curve, the control system makes the outer reel (i.e. the reel that has to follow the longest path in the curve) unwind faster than the inner reel (i.e. the reel that has to follow the shortest path in the curve). This embodiment allows for simultaneous laying of at least two cables or of at least two hoses or of at least one hose and at least one cable (referred to hereinafter as “the cable(s)/hose(s)” in an efficient and organized way along a curved path onto a ground surface. During the unwinding operation, the spacing between the cable(s)/hose(s) remains substantially constant even if the device has to navigate through very narrow curves. With such a well-organized arrangement of the cables/hoses on the ground surface, their recuperation causes less problems, even if the steerable carriage follows a path with many curves. It will be further appreciated that the two reels can be substantially laterally spaced from one another on the steerable carriage, so that on the ground surface, the simultaneously laid cable(s)/hose(s) will be separated by a rather wide space the curves, which will also contribute to facilitating their recuperation.

The control system preferably determines the speed relative to the ground surface of the drop off point of the first hose or cable and the second hose or cable and controls the unwinding speed of the first hose or cable and the second hose or cable in such a way that the unwinding speed of the first hose or cable substantially equals the speed relative to the ground surface of the drop-off point of the first hose or cable and the unwinding speed of the second hose or cable substantially equals the speed relative to the ground surface of the drop-off point of the second hose or cable.

It will be appreciated that this device allows for simple and safe simultaneous laying of the cable(s)/hose(s) in a curved path around obstacles and/or reserved traffic areas that cannot be crossed by the cable(s)/hose(s). Indeed, during the unwinding operation, the cable(s)/hose(s) are laid onto the ground surface in a substantially tension free manner. It follows that—even when driving through narrow curves during the unwinding operation—the device does not exert tension forces on the cable/hose and the spacing between the cables/hoses remains substantially constant. Thus the proposed device efficiently avoids during the unwinding operation a disarrangement of the cable/hose arrangement on the ground surface, which disarrangement could cause the cable/hose previously laid onto the ground surface to hit obstacles or persons or to penetrate into reserved traffic areas or to simply damage the cable/hose by dragging it along the ground.

In a preferred embodiment of the proposed device, the control system also controls the winding speed of the cable or hose from the reels in such a way that it corresponds to the speed relative to the ground surface of a pick-up point (The pick-up point is hereby defined as a point in a reference system attached to the carriage and located vertically above the point where the lifted cable/hose leaves the ground surface; most often the pick-up point essentially corresponds to the drop-off point). This embodiment of the proposed device allows for simple and safe recuperation of the cable/hose previously laid in a curved path around obstacles and/or reserved traffic areas that cannot be crossed by the cable/hose. Indeed, during the winding operation, the cable/hose is lifted from the ground surface without exerting a substantial tension onto the cable/hose still lying on the ground surface. Thus the proposed device also efficiently avoids during recuperation of the cable/hose (i.e. during the winding operation) a disarrangement of the cable/hose arrangement on the ground surface, which disarrangement could cause the cable/hose on the ground surface to hit obstacles or persons or to penetrate into reserved traffic areas or to be damaged in the process.

A first embodiment of the control system includes: a distance sensor associated with each of the drop-off points, so as to be able to determine the speed of the drop-off point relative to the ground surface; and a controller controlling the unwinding speed of each of the reels in function of the speed of its drop-off point.

In an alternative embodiment, which is generally more cost-efficient than the embodiment with a distance sensor, the control system includes: a steering angle sensor for measuring the steering angle of the steerable carriage; a speed sensor for measuring a representative speed of the steerable carriage; and a controller controlling the unwinding speed of each of the reels in function of the measured steering angle and the measured speed.

The steerable carriage normally includes a steerable axle with at least one wheel, wherein the steering angle sensor is then associated with this steerable axle.

In a preferred embodiment the steerable carriage includes a steering arm connected to the steerable axle, so as to be able to change the steering angle by means of this steering arm.

The steerable carriage usually comprises a drive motor for driving it, wherein the aforementioned speed sensor advantageously measures the rotational speed of the drive motor as the representative speed of the steerable carriage.

For controlling the unwinding speed of the cable or hose from the reel, the control system advantageously measures the rotation speed of the reel and determines the length of unwound cable/hose per revolution of the reel, preferably taking into account the number of superposed winding layers still present on the reel.

Also for controlling the unwinding speed of the cable or hose from the reel, an alternative embodiment of the control system includes a length measuring sensor directly measuring the length of the cable or hose that is unwound from it.

A first embodiment of such a length measuring sensor includes a measuring wheel or measuring cylinder equipped with a rotary sensor and being driven in rotation by the cable or hose.

Another embodiment of the length measuring sensor includes an optical path measuring device capable of direct surface tracking on the outer surface of the cable/hose passing in front of it and/or capable of detecting dedicated distance markers provided on the outer surface of the cable/hose.

A preferred embodiment of the device comprises two reels mounted along two opposite sides of the carriage and a servicing platform arranged on the carriage between these lateral reels. It will be appreciated that arranging the servicing platform between the lateral reels allows to access the servicing platform from two sides, thereby making the device more user-friendly.

The proposed device could of course include more than two reels mounted essentially in parallel on the steerable carriage.

### BRIEF DESCRIPTION OF DRAWINGS

The afore-described and other features, aspects and advantages of the invention will be better understood with regard to the following description of several embodiments of the invention and upon reference to the attached drawings, wherein:

FIG. 1: is a three-dimensional view of a preferred embodiment of a device in accordance with the invention;

FIG. 2: is a side view of the embodiment of FIG. 1;

FIG. 3: is a diagram illustrating a first embodiment of a control system of a device in accordance with the invention; and

FIG. 4: is a diagram illustrating a second embodiment of a control system of a device in accordance with the invention.

### DETAILED DESCRIPTION OF SEVERAL EMBODIMENTS OF THE INVENTION

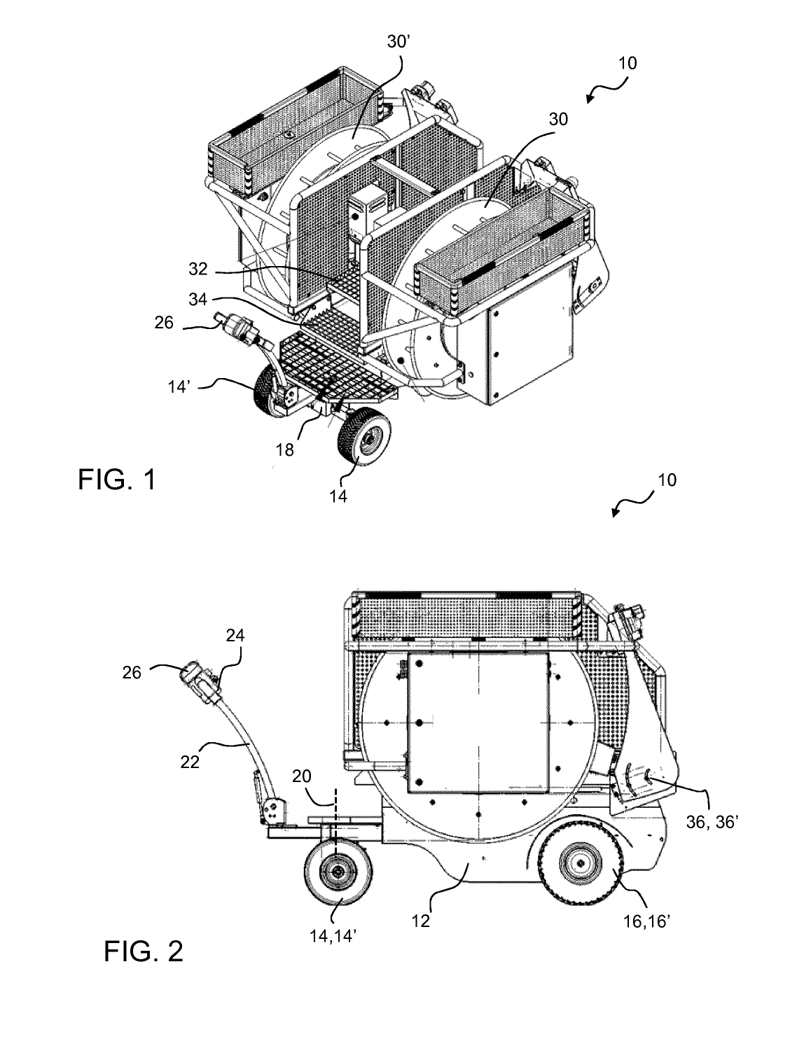

FIGS. 1 and 2 are detailed views of a preferred embodiment of a proposed device 10 for servicing an aircraft on the ground. Such a device 10 is for example used for supplying electric power and/or pressurized fluids to an aircraft parked on the apron.

The device shown in FIGS. 1 and 2 comprises a hand-guided, motor-driven carriage 12 with two front wheels 14, 14′ and two rear wheels 16, 16′. The two front wheels 14, 14′ are mounted on a steerable front axle 18, which is pivotable about a vertical axis 20. A steering arm 22 is connected to the steerable front axle 18, so as to be able to change the steering angle and to allow relatively narrow curves of the carriage 12. In an alternative embodiment, the two front wheels 14, 14′ may be replaced by one single steerable front wheel. The two rear wheels 16, 16′ are, at least in this embodiment, not steerable and they are driven by an electric drive motor (not seen in FIGS. 1 and 2). This drive motor can be controlled by means of control elements 24 located on a handle bar 26 of the steering arm 22, allowing, for example, to switch between forward and reverse driving of the carriage 12 and to control its speed.

The carriage 12 supports two reels 30, 30′, which are mounted along its two opposite sides, i.e. laterally of the carriage 12. Each of these reels 30, 30′ can be used for storing thereon a cable (for example a power cable for supplying the parked aircraft with electric energy) or a hose (for example a hose for supplying the parked aircraft with a pressurized fluid or a hose for evacuating a fluid from the aircraft). Both reels 30, 30′ may be equipped with a cable or with a hose, or one of them may be equipped with a cable and the other one with a hose. In FIG. 1, both reels 30, 30′ are shown without the cable or hose stored thereon. (In the following, different aspects of the invention will be described only with reference to cables stored on the reels 30, 30′, but the invention would of course function in the same way with hoses stored on the reels 30, 30′ or with a hose on one reel and a cable on the other reel.)

A raised servicing platform 32 is advantageously arranged on the carriage 12 between the two lateral reels 30, 30′. From this servicing platform 32, the ground technician can easily proceed to the connection of the cable to the aircraft. The servicing platform 32 is advantageously accessible from the front end and the rear end of the carriage 12 by means of stairs, wherein in FIG. 1, only the stairs 34 at the front end (i.e. the end equipped with the steering arm 22) of the carriage can be seen (the opposite rear end being however equipped with similar stairs). It will be noted that the arrangement of the reels 30, 30′ laterally of the servicing platform 32 allows to make the latter accessible from both ends of the carriage 12, but also results in that both reels 30, 30′ are laterally spaced from one another by a distance in the range of 50 cm to 120 cm.

When the device 10 is needed for supplying electric power to an aircraft, a ground technician moves it from an electric energy supply station towards the aircraft. During this movement, the cables are progressively unwound from their reels 30, 30′ and are laid behind the moving device 10 onto the ground surface. When the device 10 is no longer needed at the aircraft, the ground technician moves it back to the electric energy supply station, following the path traced by the cable pair lying on the ground surface, wherein the cables are lifted up in front of the moving device 10 and wound again onto their respective reel 30, 30′.

In FIG. 2, reference number 36 identifies a guiding and spooling device associated with the reel 30. A similar guiding and spooling device 36′ is associated with the reel 30′, but it is not seen in FIG. 2. During the unwinding operation, each of these guiding and spooling devices 36, 36′ guides the cable from its respective reel 30, 30′ onto the ground surface, thus warranting that the cable drops from the moving device 10 in a zone that is basically not larger than the width of the respective reel 30, 30′. During the winding operation, the guiding and spooling devices 36, 36′ lifts the cable from the ground surface and guides it in a controlled manner onto the respective reel 30, 30′, usually forming spiral windings in radially superposed layers. In a preferred embodiment, the guiding and spooling device 36, 36′ centres the cable during the unwinding operation substantially in a vertical midplane of the respective reel 30, 30′.

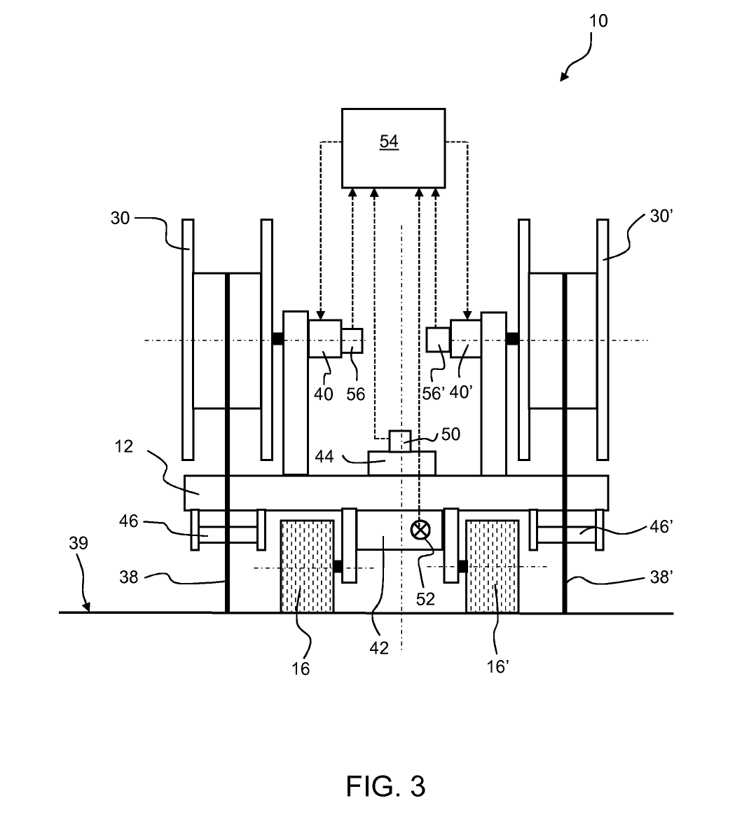

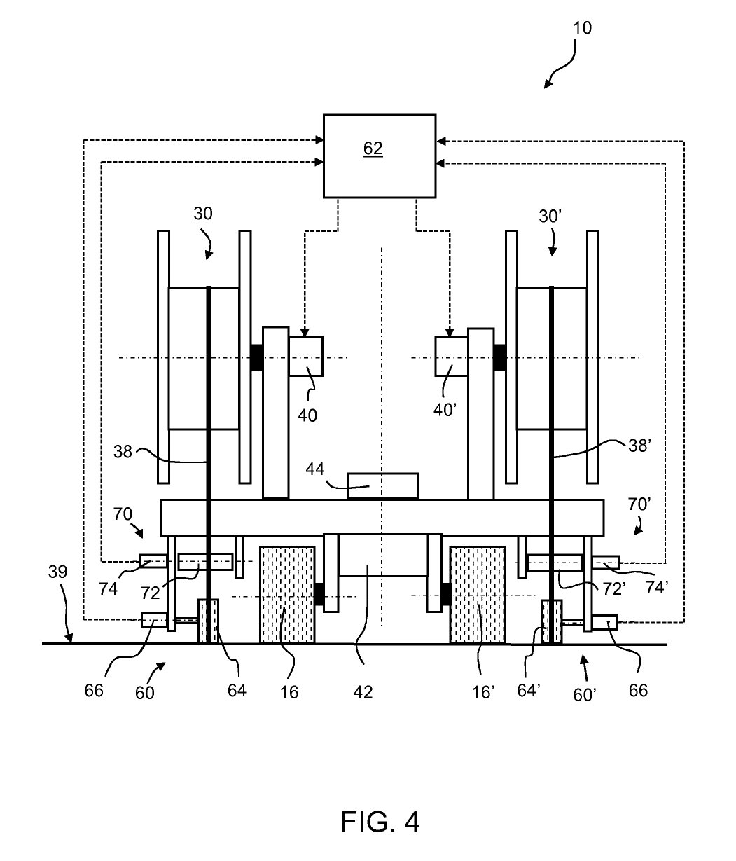

Turning now to FIGS. 3 and 4, an advantageous control system for the unwinding and winding operations is described. Both figures show a rather schematic elevation view of the rear end of device 10, i.e. the end that is opposite of the steering arm 22. Reference 38 identifies a cable (or a hose) 38 wound on the reel 30, and reference 38′ a cable (or a hose) 38′ wound on the reel 30′. Both cables 38, 38′ are shown while being unwound from their respective reel 30, 30′ and laid onto a ground surface 39 behind the moving device 10. Each of the reels 30, 30′ is driven by an electric reel-motor 40, 40′. It will be noted that each of these reel-motors 40, 40′ can also temporarily operate as a reel-brake for decelerating or stopping the respective reel 30, 30′, if necessary. Furthermore, each of these reel-motors 40, 40′ advantageously drives its reel 30, 30′ via a hydrodynamic transmission, which interrupts torque transmission to the reel 30, 30′ at a preset torque; i.e. when the force exerted onto the cable exceeds a certain value (corresponding to the preset torque) the transmission starts to slip. An electric drive motor 42 drives the rear wheels 16, 16′ of the carriage 12. Reference number 44 schematically represents the steering mechanism used to change the steering angle of the front wheels 14, 14′. Reference numbers 46, 46′ point to a schematic representation of guiding devices associated with the reels 30, 30′. During the unwinding operation, the guiding device 46, 46′ guides the cable 38, 38′ from its reel 30, 30′ onto the ground surface 39, and during the winding operation, it lifts the cable 38, 38′ from the ground surface 39 and guides it back onto its respective reel 30, 30′. In a preferred embodiment, each of these guiding devices 46, 46′ is a component of one of the above-described guiding and spooling devices 36, 36′; i.e. the guiding device 46, 46′ is supplemented with a spooling device (not shown), which spools the cable 38, 38′ onto the reel 30, 30′ during the winding operation and advantageously centres the cable 38, 38′ on the guiding device 46, 46′ during the unwinding operation.

The control systems illustrated by FIGS. 3 and 4 both control the unwinding speed, respectively the winding speed, of each of the reels 30, 30′ in such a way that the unwinding speed, respectively the winding speed, of the cable 38, 38′ from its reel 30′, 30″ substantially equals the speed of its drop-off point, respectively of its pick-up point, relative to the ground surface 39. The drop-off point in case of an unwinding operation, respectively the pick-up point in case of a winding operation, is hereby defined as a point in a reference system attached to the carriage 12 that is located vertically above the point where, in case of the unwinding operation, the dropped cable 38, 38′ touches the ground surface 39, respectively where, in case of the winding operation, the lifted cable 38, 38′ leaves the ground surface 39. For example, a fixed drop-off point, respectively a fixed pick-up point, of each reel 30, 30′ may be conventionally defined as the centre of its guiding device 46, 46′. Alternatively, a movable drop-off or pick-up point of each reel 30, 30′ may be defined as the point where the cable 38, 38′ touches its guiding device 46, 46′ at a certain moment. Generally the “drop-off point” and the “pick-up point” of the cable reel 30, 30′ coincide or are at least located very close to one another, so that the “pick-up point” can most often be assimilated with the “drop-off point” of the cable reel 30, 30′. Therefore, the following description will refer to the “drop-off point” also for the winding operation.

The device 10 equipped with a control system as described in the previous paragraph is of particular advantage if this device 10 has to navigate through narrow curves during the unwinding and winding operation, for example for avoiding obstacles or reserved traffic areas. In a left curve, the proposed control system makes the outer right reel 30′, which has to travel a longer path than the inner left reel 30, unwind faster than the inner left reel 30. In a right curve, it makes the outer left reel 30 unwind faster than the inner right reel 30. It will further be noted that, during an unwinding operation, both cables 38, 38′ are laid onto the ground surface 39 in a substantially tension free manner; similarly during a winding operation, both cables 38, 38′ are also lifted from the ground surface 38, 38′ in a substantially tension free manner. It follows that—even when driving through narrow curves—the device 10 does not exert tension forces on the cables 38, 38′, tensions that could disarrange the cable portions previously arranged in a controlled manner onto the ground surface 39. Thus it becomes possible to reliably lay the cables 38, 38′ in a curved path around obstacles or reserved traffic areas. Furthermore, during the unwinding operation the spacing between the cables 38, 38′ remains constant even if the device 10 has to navigate through narrow curves. Last but not least, during the winding operation, the device 10 must only follow the fictive path delimited by the generously spaced cables 38, 38′ on the ground surface 39, to be able to lift up these cables 38, 38′ very smoothly and without disarranging the initial arrangement of the cable portions still resting on the ground surface 39.

FIG. 3 shows a first preferred embodiment of such a control system. In this embodiment, a steering angle sensor 50 measures the steering angle of the carriage 12, and a speed sensor 52 measures a representative speed of the carriage 12. In the embodiment of FIG. 3, the speed sensor 52 is e.g. associated with the electric drive motor 42, so as to measure its rotational speed as a representative speed of the carriage 12. On the basis of these two parameters (i.e. the steering angle and the speed of the carriage 12), a controller 54 controls the two reel-motors 40, 40′ in such a way that the unwinding speed, respectively the winding speed, of each of the cables 38, 38′ substantially corresponds to the speed of its drop-off point relative to the ground surface 39.

In the embodiment of FIG. 3, the unwinding speed, respectively the winding speed, of each of the cables 38, 38′ is computed by the controller 54 using as a first parameter, the rotation speed of the reel 30, 30′, which is e.g. measured via a rotational-speed sensor 56, 56′ associated with the reel 30, 30′, and as a second parameter, a computed cable length that is unwound per revolution from the reel 30, 30′, respectively wound per revolution onto the reel 30, 30′. This cable length per reel revolution is preferably computed taking into account the number of superposed winding layers momentarily stored on the reel 30, 30′. More particularly, the number of superposed winding layers momentarily stored on the reel 30, 30′ is used to determine a corrected diameter of the next winding to be unwound from or wound onto the reel 30, 30′. This corrected diameter is then used for computing the cable length of this next winding. The controller 54 determines the number of superposed winding layers on the reel 30, 30′ e.g. by monitoring the total length of the cable 38, 38′ that is unwound from the reels 30, 30′, so as to be capable of determining the total length of the cable 38 that is momentarily wound on the reel 30, 30′. Alternatively, the number of superposed winding layers on the reels 30, 30′ may also be determined by sensors (not shown) associated with each reel 30, 30′ or on the basis of spooling parameters received from the guiding and spooling device 36, 36′ associated with the reel 30, 30′.

FIG. 4 shows a second preferred embodiment of the control system. In this embodiment, the control system includes a distance sensor 60, 60′ associated with each of the drop-off points, so as to be able to determine the distance travelled by the respective drop-off point relative to the ground surface 39 and thereby its speed relative to the ground surface 39. A controller 62 then controls the unwinding or winding speed of each of the reels 30, 30′ in function of the speed of its drop-off point. Each of these distance sensors 60, 60′ comprises e.g. a distance measuring wheel 64, 64′, which is pressed (e.g. by resilient means or by a weight) against the ground surface 39, as close as possible to the respective drop-off point, so as to be driven in rotation when the device 10 moves over the ground surface 39, and a rotational sensor 66, 66′ associated with each of the distance measuring wheels 64, 64′. Alternatively, the rear wheels 16, 16′ can also be used as distance measuring wheels, wherein the fact that these wheels 16, 16′ are most often significantly spaced from the drop-off point of the respective reel 30, 30′ can normally be compensated by applying a compensation algorithm in the controller 62.

In the embodiment of FIG. 4, the unwinding speed, respectively the winding speed, of each of the cables 38, 38′ is determined by directly measuring, by means of a cable length measuring sensor 70, 70′, the length of the cable 38, 38′ that is unwound from the reel 30, 30′, respectively wound onto the reel 30, 30′. According to FIG. 4, the length measuring sensor 70, 70′ includes a measuring cylinder 72, 72′ equipped with a rotary sensor 74, 74′. The moving cable 38, 38′ is in frictional contact with the measuring cylinder 72, 72′, so as to drive the latter in rotation without slippage. The number of revolution measured by each rotary sensor 74, 74′ is used by the controller 62 to determine the unwinding speed, respectively the winding speed, of each of the cables 38, 38′. In an alternative embodiment, the cable length measuring sensor includes an optical path measuring device capable of surface tracking on the outer surface of the cable 38, 38′ passing in front of it. Alternatively or additionally, the optical path measuring device may also detect dedicated distance markers provided on the outer surface of the cable 38, 38′.

It will be noted that features or sensors of the embodiment of FIG. 3 may of course be combined with features or sensors of the embodiment of FIG. 4 and vice versa. For example: in the embodiment of FIG. 3 the unwinding speed, respectively the winding speed, of each of the cables 38, 38′ can e.g. be measured as described for the embodiment of FIG. 4; or in the embodiment of FIG. 4, the distance sensors 60, 60′ may be replaced by the steering angle sensor 50 and the speed sensor 52 described for the embodiment of FIG. 3.

List of Reference Signs

| | |
|---|---|
| 10 | device for servicing an |
| | aircraft on the ground |
| 12 | carriage |
| 14, 14′ | front wheels |
| 16, 16′ | rear wheels |
| 18 | steerable front axle |
| 20 | vertical axis of 18 |
| 22 | steering arm |
| 24 | control elements |
| 26 | handle bar |
| 30, 30′ | reels |
| 32 | servicing platform |
| 34 | stairs |
| 36, 36′ | guiding and spooling device |
| 38, 38′ | cable (or a hose) |
| 39 | ground surface |
| 40, | reel-motor |
| 40′ | |
| 42 | drive motor |
| 46 | guiding device |
| 50 | angle sensor |
| 52 | speed sensor |
| 54 | controller |
| 56, 56′ | rotational-speed sensor |
| 60, 60′ | distance sensor |
| 62 | controller |
| 64, 64′ | distance measuring wheel |
| 66, 66′ | rotational sensor |
| 70, 70′ | length measuring sensor |
| 72, 72′ | measuring cylinder |
| 74, 74′ | rotary sensor |

1. A device for servicing an aircraft on the ground comprising:
a steerable carriage having a first lateral side and an opposite second lateral side;
a first reel mounted along the first lateral side of the steerable carriage configured to unwind a first hose or a cable onto a ground surface, wherein the first hose or a cable has a drop off point near the first lateral side of the steerable carriage;
a second reel mounted along the second lateral side of the steerable carriage configured to unwind a second hose or a cable onto the ground surface, wherein the second hose or a cable has a drop off point near the second lateral side of the steerable carriage; and
a control system configured to control the unwinding speed of the cable or hose from of each of the reels in such a way that in a curve, the control system makes the outer reel unwind faster than the inner reel.

2. The device according to claim 1, wherein:
the control system is configured to determine the speed relative to the ground surface of the drop off point of the first hose or cable and the speed relative to the ground surface of the drop off point of the second hose or cable and to control the unwinding speed of the first hose or cable and the second hose or cable in such a way that the unwinding speed of the first hose or cable substantially equals the speed relative to the ground surface of the drop-off point of the first hose or cable and the unwinding speed of the second hose or cable substantially equals the speed relative to the ground surface of the drop-off point of the second hose or cable.

3. The device as claimed in claim 1, wherein the control system further comprises:
a distance sensor associated with each of the drop-off points, so as to be able to determine the speed of the drop-off point relative to the ground surface; and
a controller configured to control the unwinding speed of each of the reels in function of the speed of its drop-off point.

4. The device as claimed in claim 1,
wherein the control system further comprises:
a steering angle sensor configured to measure the steering angle of the steerable carriage;
a speed sensor configured to measure a representative speed of the steerable carriage; and
a controller configured to control the unwinding speed of each of the reels in function of the measured steering angle and the measured speed.

5. The device as claimed in claim 4, wherein the steerable carriage includes a steerable axle with at least one wheel, wherein a steering angle sensor is then associated with this steerable axle.

6. The device as claimed in claim 5, wherein the steerable carriage includes a steering arm connected to the steerable axle, so as to be able to change the steering angle by means of the steering arm.

7. The device as claimed in claim 4, wherein the steerable carriage comprises a motor for driving it, the speed sensor configured to measure the rotational speed of the motor.

8. The device as claimed in claim 1, wherein for controlling the unwinding speed of the cable or hose from each of the reels, the control system is configured to measure the rotation speed of the respective reel and to determine the length of unwound cable per revolution of the reel.

9. The device as claimed in claim 8, wherein for determining the length of unwound cable per revolution of the reel, the control system is configured to take into account the number of superposed winding layers still present on the reel.

10. The device as claimed in claim 1, wherein for controlling the unwinding speed of each of the reels, the control system includes a length measuring sensor directly measuring the length of the cable or hose that is unwound from it.

11. The device as claimed in claim 10, wherein the length measuring sensor includes a measuring wheel or measuring cylinder equipped with a rotary sensor and being driven in rotation by the cable or hose.

12. The device as claimed in claim 10, wherein the length measuring sensor includes an optical path measuring device capable of surface tracking on the outer surface of the cable passing in front of it and/or capable of detecting dedicated distance markers provided on the outer surface of the cable.

13. The device as claimed in claim 1, wherein the control system is further configured to control the unwinding torque of each of the reels, so as to warrant that its unwinding torque remains within a preset range.

14. The device as claimed in claim 1, further comprising a raised servicing platform arranged on the carriage between the two lateral reels.

15. The device as claimed in claim 1, wherein the control system also is configured to control the winding speed of the cable or hose from of each of the reels in such a way that it substantially corresponds to the speed relative to the ground surface of a pick-up point of the respective reel.
